(19) United States
(12) Patent Application Publication
(10) Pub. No.: US 2016/0048800 A1
(43) Pub. Date: Feb. 18, 2016

(54) SYSTEMS AND METHODS FOR SHIPMENT TRACKING

(71) Applicant: Laird Technologies, Inc., Earth City, MO (US)

(72) Inventor: Benjamin John Whitten, Berkshire (GB)

(21) Appl. No.: 14/676,149

(22) Filed: Apr. 1, 2015

Related U.S. Application Data
(60) Provisional application No. 62/037,675, filed on Aug. 15, 2014.

(51) Int. Cl. G06Q 10/08; H04W 4/00

(52) U.S. Cl. CPC G06Q 10/0833; H04W 4/008

(57) ABSTRACT

According to various aspects, exemplary embodiments are disclosed of systems and methods related to shipment tracking for trains. In an exemplary embodiment, a shipment tracking system generally includes one or more Bluetooth nodes positionable onboard one or more cars of a train. The one or more Bluetooth nodes are configured to transmit shipment information for the one or more cars. A gateway device is configured to receive shipment information for the one or more cars. The gateway device is configured to transmit payload information to a database.

### CROSS-REFERENCE TO RELATED APPLICATION

This patent application claims the benefit of and priority to U.S. Provisional Patent Application No. 62/037,675 filed Aug. 15, 2014. The entire disclosure of the above application is incorporated herein by reference.

### FIELD

The present disclosure generally relates to systems and methods for shipment tracking, including Bluetooth communications and networks.

### BACKGROUND

This section provides background information related to the present disclosure which is not necessarily prior art.

Bluetooth is a wireless technology standard that may be used to transfer data over short distances using short-wavelength ultrahigh frequency (UHF) radio waves in the ISM (Industrial Scientific and Medical) band from 2.4 Gigahertz (GHz) to 2.485 GHz. Bluetooth low energy (BLE) is a related technology for providing communications with reduced power consumption. Separately, rail shipments may be handled manually by operators shunting trains and train cars around train yards to construct shipments carrying cargo for many different clients at one time.

### SUMMARY

This section provides a general summary of the disclosure, and is not a comprehensive disclosure of its full scope or all of its features.

According to various aspects, exemplary embodiments are disclosed of systems and methods related to shipment tracking for trains. In an exemplary embodiment, a shipment tracking system includes one or more Bluetooth nodes positionable onboard one or more cars of a train. The one or more Bluetooth nodes are configured to transmit shipment information for the one or more cars. A gateway device is configured to receive shipment information for the one or more cars. The gateway device is configured to transmit payload information to a database

In another exemplary embodiment, a shipment tracking method for a train having one or more cars is disclosed. The method includes obtaining, via one or more Bluetooth nodes onboard the one or more cars of the train, shipment information for the one or more cars. The method also includes relaying, via at least one of the one or more Bluetooth nodes, the shipment information for the one or more cars to a gateway device onboard the train. The method further includes transmitting, via the gateway device, payload information to a database.

In a further exemplary embodiment, a method of providing a train with a shipment tracking system is disclosed. The method includes positioning one or more Bluetooth nodes onboard one or more cars of the train. The one or more Bluetooth nodes are configured to transmit shipment information for the one or more cars. The method also includes positioning a gateway device onboard the train. The gateway device is configured to receive shipment information for the one or more cars. The gateway device is configured to transmit payload information to a database.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a diagram of an example shipment tracking system according to one or more aspects of the present disclosure; and

FIG. 2 is a diagram of example directed Bluetooth signal beams between two Bluetooth nodes of the shipment tracking system shown in FIG. 1.

### DETAILED DESCRIPTION

Example embodiments will now be described more fully with reference to the accompanying drawings.

The inventor has recognized that rail shipments may be handled manually, with operators shunting trains around at rail yards to construct shipments for many clients at a time, which may lead to mistakes and missing materials.

Disclosed herein are exemplary embodiments of shipment tracking systems and methods, using Bluetooth communications. In one example embodiment, one or more cars (e.g., carriage, railroad freight car, etc.) of a train may have a Bluetooth node, which may include modules, chipsets, devices, beacons, etc.. The Bluetooth node may have a universally unique identifier (UUID) defining shipment information (e.g., destination, contents or cargo of the train car, identification of the car, etc.). Using Bluetooth communications (e.g., Bluetooth 4.1 specification, etc.), the shipment information can be relayed along the train to a gateway device onboard the train. The gateway device may be onboard the train's engine (e.g., locomotive, etc.), onboard the caboose, etc. The gateway device (e.g., a global system for mobile communications (GSM) gateway, etc.) may be configured to transmit a digital payload of the train via GSM, long-term evolution (LTE), etc. By way of example, the payload information may include an aggregation of shipment information for each car of the train. The gateway device may include a global positioning system (GPS) receiver or other satellite navigation receiver (e.g., global navigation satellite system (GLONASS) receiver, etc.). The gateway device may transmit location information for the train along with the payload information.

Some of the example embodiments described herein may allow granular tracking of shipments in real time. Cars lost in depots or put in the wrong shipment can be flagged. Clients may login to a computer system and see an overview of all shipments specific to the client on a rail network.

According to an example embodiment of the present disclosure, a shipment tracking system includes one or more Bluetooth nodes positionable onboard one or more cars of a train. The one or more Bluetooth nodes are configured to transmit shipment information for the one or more cars. A gateway device is configured to receive shipment information for the one or more cars. The gateway device is configured to transmit payload information to a database.

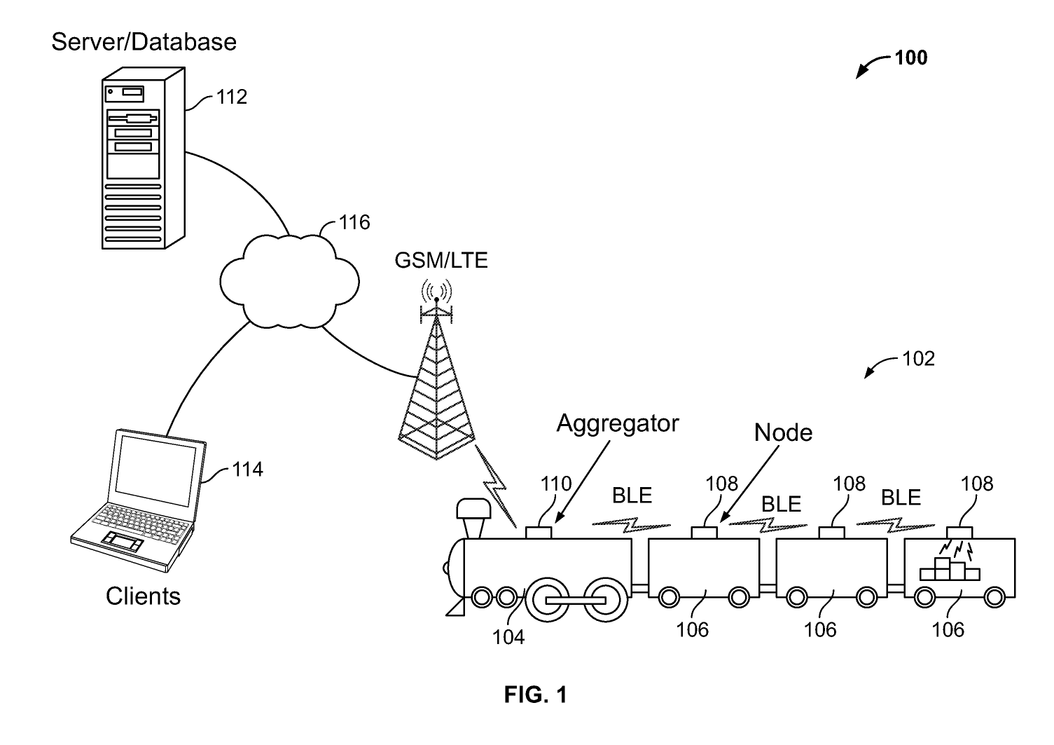

FIG. 1 illustrates an example shipment tracking system 100 according to one or more aspects of the present disclosure. The system includes a train 102 having an engine 104 and a plurality of cars 106. The train 102 may include any vehicles suitable for transporting cargo along a rail system, including freight trains, light rail, monorails, magnetic levitation trains, etc. The engine 104 may include any suitable locomotive for moving the train, including steam engines, diesel engines, electric engines, etc. The cars 106 may include any suitable containers for carrying cargo, including carriages, freight cars, railroad cars, railcars, etc. Although FIG. 1 illustrates a train 102 having only one engine 104 and three cars 106, other trains may include more engines and/or more or less cars.

Each car 106 may include a Bluetooth node 108 (e.g., tag node, etc.). As shown in FIG. 1, a Bluetooth node 108 is onboard each car 106. The Bluetooth node 108 may be any Bluetooth instance, including a Bluetooth chipset, device, module, beacon, etc. The Bluetooth node 108 may communicate using any Bluetooth protocol (e.g., Bluetooth 4.0, Bluetooth 4.1, etc.). The Bluetooth node 108 may use a Bluetooth low energy (BLE) protocol. For example, each Bluetooth node 108 may be a BLE beacon.

The Bluetooth node 108 may obtain shipment information for the contents and/or identity of its corresponding car 106 on which the Bluetooth node 108 is located. The Bluetooth node 108 may have a universally unique identifier (UUID) defining shipment information for its corresponding car 106. The shipment information may include the identity of the car, contents of the car, who the car belongs to, status information for the car, a destination for the car, etc.

The Bluetooth node 108 may obtain the shipment information using any suitable method. For example, the Bluetooth node 108 could have a characteristic that could be written when its corresponding car 106 is loaded, by storing information such as car contents, destination, client, etc. The shipment information may be read from the cargo directly if the cargo includes suitably programmed beacons, tags (e.g., RFID tags), etc. If the train 102 is coupled with a management system, the UUID of the Bluetooth node 108 may simply identify its corresponding car 106 and the management system can track the shipment information for the car 106 based on information updated in the management system when the car 106 is loaded with cargo. Example rail management systems include Laird Technologies' Rail Insight and Laird Link systems.

Each Bluetooth node 108 is configured to transmit shipment information for its corresponding car 106 to another Bluetooth node 108 corresponding to a different car 106 (e.g., a different car that is in front of the corresponding car 106 and closer to the engine 102, etc.). Each Bluetooth node 108 may also be configured to receive shipment information from one or more Bluetooth nodes 108 corresponding to cars 106 farther from the engine 104, and relay the received shipment information to another Bluetooth node 108 corresponding to a car 106 closer to the engine 104. For example, each Bluetooth node 108 may be configured to receive shipment information for each car 106 behind the Bluetooth node 108, and then transmit the shipment information for all cars 106 behind the Bluetooth node 108 to a car 106 ahead of the Bluetooth node 108. Thus, each Bluetooth node 108 can relay shipment information towards the engine 104 in this example. When relaying shipment information, the Bluetooth node 108 may add its own shipment information corresponding to its car 106 to the received shipment information from other cars 106.

Although FIG. 1 illustrates each car 106 having a Bluetooth node 108, in other embodiments some cars 106 may not include Bluetooth nodes 108 and/or some cars 106 may include more than one Bluetooth node 108. Although each Bluetooth node 108 may be configured to transmit and receive shipment information to/from other Bluetooth nodes 108 corresponding to other cars, some Bluetooth nodes 108 may be configured only to transmit shipment information (e.g., a Bluetooth node 108 corresponding to a car 106 at the end of the train 102 closest to the gateway device 110, etc.), and some Bluetooth nodes 108 may be configured to transmit shipment information only to the gateway device 110 (e.g., the Bluetooth node 108 corresponding to the car 106 closest to the gateway device 110, etc.).

The Bluetooth nodes 108 may be configured to receive, transmit, relay, etc. the shipment information using any suitable approach. For example, the Bluetooth nodes 108 may transmit and receive shipment information using methods disclosed in commonly assigned U.S. patent application Ser. No. 14/283,361, filed May 21, 2014, by Tailor et al., the disclosure of which is hereby incorporated by reference.

The transmitted and received shipment information may include any suitable Bluetooth data, including data transferred according to the Bluetooth Attribute Protocol (ATT), the Bluetooth Generic Attribute Profile (GATT), data formatted as services and/or characteristics of a Bluetooth device, etc. Metadata may be used to tag the Bluetooth data (e.g., shipment information) as belonging to an original Bluetooth node 108. The metadata may include expedited custom characteristics, descriptors, etc.

The Bluetooth node 108 may include first and second communication modules coupled back to back via a hardware interface, and may incorporate suitable firmware. For example, the first and second communication modules may be coupled via a universal asynchronous receiver/transmitter (UART), an inter-integrated circuit (I2C), a serial peripheral interface bus (SPI), etc. The interface between the first and second communication modules may allow the modules to send information from one module to the other. For example, the interface may allow the first communication module to provide received attributes to the second communication module. The interface may be a one-way interface or a two-way interface, and may allow the two modules to share information without the need for a Bluetooth connection between them. Because the two modules do not need to share a Bluetooth connection, they are free to connect to other Bluetooth modules. For example, the first communication module may connect to a Bluetooth node 108 farther down the train 102 to receive shipment information data, pass the data along to the second communication module via the hardware interface, and allow the second communication module to transmit corresponding shipment information data to a Bluetooth node 108 farther up the train 102.

As another example, a Bluetooth node 108 may be capable of acting as both a master device and a slave device at substantially the same time (e.g., by communicating as a master device and a slave device simultaneously, by alternating between master device communications and slave device communications, etc.). The ability to act as both a master device and a slave device may be possible in Bluetooth devices having a specification which allows for this configuration. In this embodiment, the Bluetooth node 108 is configured to act as a Bluetooth master for receiving shipment information data from one or more Bluetooth nodes 108 farther down the train 102. The Bluetooth node 108 is also configured to act as a Bluetooth slave for transmitting shipment information data corresponding to the received shipment information data to another Bluetooth node 108 farther up the train 102. The Bluetooth node 108 is configured to process the shipment information data received when the Bluetooth node 108 is acting as a Bluetooth master to generate corresponding shipment information data to be transmitted when the Bluetooth node 108 is acting as a Bluetooth slave.

Bluetooth nodes 108 in the network may communicate via a Bluetooth low energy (BLE) communication protocol (e.g., Bluetooth 4.0, 4.1, etc.), which may provide ultra-low power network communication. The network may be a low power distributed system where node status (e.g., status of a Bluetooth node 108) and/or existence propagates throughout the network such that each node (e.g., Bluetooth node 108) contains a complete copy of the network as a whole.

The train 102 includes a gateway device 110. For example, the gateway device 110 may be onboard the engine 104, onboard one of the cars 106, onboard a caboose, etc. In the example shown in FIG. 1, the engine 104 includes the gateway device 110, such that the Bluetooth nodes 108 are shown transmitting or relaying the shipment information from Bluetooth node 108 to Bluetooth node 108 in a forward car-to-car direction along the train 102 towards the engine 104 and the gateway device 110 onboard the engine 104. Alternatively, the gateway device 110 may be onboard a caboose or located on another car at or towards the back of the train 102. In which case, the Bluetooth nodes 108 may be collectively or cooperatively operable to transmit or relay shipment information from Bluetooth node 108 to Bluetooth node 108 in a backward car-to-car direction along the train 102 towards the caboose or other car having the gateway device 110 onboard.

The gateway device 110 may include a Bluetooth aggregator node configured to receive shipment information from another Bluetooth node 108. The shipment information for some or all of the cars 106 of the train 102 can be relayed to the gateway device 110. The gateway device 110 can aggregate all of the shipment information. The shipment information may be aggregated into payload information. Therefore, the payload information may include shipment information for some or all of the cars 106 of the train 102, such that the gateway device 110 has a digital payload of the train 102.

The gateway device 110 may be configured to transmit the payload information to a database 112. The database 112 may include any suitable computing device, including servers, desktop computers, laptops, tablets, smartphones, etc. The database 112 may store payload/shipment information for multiple trains 102. The database 112 may be part of a rail management system, such as Laird's Technologies' Rail Insight and Laird Link, or any other suitable rail management system portal, website, etc.

Clients or users (e.g., customers shipping cargo on the rail system, etc.) may be able to access the database 112 via a computing device 114 (e.g., desktop computer, laptop, tablet, smartphone, or other client computer device, etc.). The database 112 may be accessed via a rail management system, portal, website, etc. to view status, payload, shipment, etc. information for the client's cargo. For example, a client may login to the database 112 and track all shipments belonging to the client across multiple trains 102. Operators of the rail systems may also access the database 112 to track shipments and avoid misplaced/incorrectly routed cars 106. The database 112 may be accessed via a network 116, which may include any suitable network (e.g., wireless network, wired network, wide area network (WAN), local area network (LAN), the Internet, etc.).

The gateway device 110 may transmit payload information to the database 112 via any suitable transmission technology, including cellular systems (e.g., global system for mobile communications (GSM), long-term evolution (LTE), etc.), wireless networks, etc. The payload information may also be transmitted via network 116.

The gateway device 110 may include a satellite navigation system receiver, such as a global positioning system (GPS) receiver, global navigation satellite system (GLONASS) receiver, etc. In this example, the gateway device 110 includes a GPS receiver to determine location of the train 102. The gateway device 110 may transmit location information along with payload information to the database 112, thereby indicating a location or position of the train 102 and payload of the train 102.

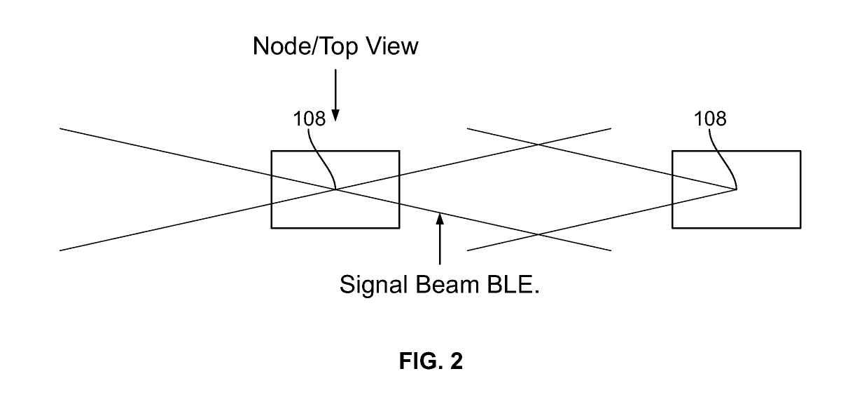

As shown in FIG. 2, each Bluetooth node 108 may be configured to transmit Bluetooth communication signals using a directional signal beam. The antenna beam may be directional (e.g., a polar conical beam, etc.) and may be limited in power, to limit communication to only other cars 106 of the train 102 (e.g., between adjacent Bluetooth nodes 108, etc.). For example, each Bluetooth node 108 may be configured to transmit/receive shipment information by generating/receiving a conical beam in a direction fore and/or aft of the Bluetooth node 108 with respect to a longitudinal direction of the train 102. This creates a relay network of Bluetooth nodes 108 along the train 102, and may inhibit Bluetooth nodes 108 from communicating with other devices which are not part of the train 102 (e.g., other trains traveling on adjacent tracks in an opposite direction, other trains or cars positioned on adjacent tracks in a rail yard, etc.).

An exemplary embodiment of a shipment tracking method for a train includes obtaining, via one or more Bluetooth nodes onboard one or more cars of the train, shipment information for the one or more cars. The method also includes relaying, via at least one of the one or more Bluetooth nodes, the shipment information for the one or more cars to a gateway device onboard the train. The method further includes transmitting, via the gateway device, payload information to a database. The payload information may include the shipment information for the one or more cars, e.g., each car of the train, etc. The shipment information may include contents of a car, a destination of a car, an identification of a specific car, etc.

Relaying shipment information may include, at one or more of a plurality of Bluetooth nodes, receiving shipment information from another Bluetooth node corresponding to a car farther from the gateway device and transmitting the received shipment information to another Bluetooth node corresponding to a car closer to the gateway device.

Transmitting payload information may include transmitting location information indicating a location of the train. Relaying may include directing a Bluetooth signal along a longitudinal axis of the train to inhibit Bluetooth communication with Bluetooth nodes outside of the train.

A further exemplary embodiment includes a method of providing a train with a shipment tracking system. In this example, the method includes positioning one or more Bluetooth nodes onboard one or more cars of the train. The one or more Bluetooth nodes are configured to transmit shipment information for the one or more cars. The method also includes positioning a gateway onboard the train. The gateway device is configured to receive shipment information for the one or more cars. The gateway device is configured to transmit payload information to a database. The payload information may include the shipment information for the one or more cars.

Exemplary embodiments of shipment tracking systems and method are disclosed herein that may provide one or more (but not necessarily any or all) of the following advantages. Exemplary shipment tracking systems may include train cars each fitted with a Bluetooth tag node, with a limited power and directional antenna to form a network only with other Bluetooth nodes on the same train. The shipment information for each car may be repeated at each Bluetooth node to form a complete payload of the train, including which cars the train is carrying, who each car is for, what each car contains, status information, etc. The head end of the train (e.g., engine, etc.) may only need to query its closest neighbor to determine what the complete train is carrying, and could relay the information over a cellular connection along with location data (e.g., GPS data, GLONASS data, etc.) to a database service (e.g., rail management system) with a client front end to allow tracking of shipment information for multiple trains. This may provide immediate feedback as trains are being constructed and cars are being shunted around a rail yard, etc., to determine if any cars are out of place or missing. The system may allow for granular tracking of shipments in real time, and cars lost in train depots or put in a wrong train shipment can be flagged.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purposes of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A shipment tracking system for a train having one or more cars, the system comprising:
one or more Bluetooth nodes positionable onboard the one or more cars and configured to transmit shipment information for the one or more cars; and
a gateway device positionable onboard the train and configured to receive shipment information for the one or more cars, the gateway device configured to transmit payload information to a database, the payload information including the shipment information for the one or more cars.

2. The system of claim 1, wherein:
the one or more Bluetooth nodes comprise a plurality of Bluetooth nodes;
the train includes a plurality of cars each including at least one of the plurality of Bluetooth nodes;
each Bluetooth node configured to transmit shipment information for a corresponding car on which it is positioned to another Bluetooth node on another car that is closer to the gateway device; and
the gateway device is configured to receive shipment information for each of the plurality of cars and to transmit payload information including an aggregation of shipment information for each of the plurality of cars of the train to a database.

3. The system of claim 1, wherein:
the train includes an engine having the gateway device; and
the one or more Bluetooth nodes comprise a plurality of Bluetooth nodes each configured to receive shipment information from another Bluetooth node on a car farther from the engine and relay the received shipment information to another Bluetooth node on a car closer to the engine;
whereby the plurality of Bluetooth nodes are cooperatively operable for transmitting shipment information in a forward car-to-car direction along the train to the gateway device.

4. The system of claim 1, wherein:
the train includes a caboose having the gateway device; and
the one or more Bluetooth nodes comprise a plurality of Bluetooth nodes each configured to receive shipment information from another Bluetooth node on a car farther from the caboose and relay the received shipment information to another Bluetooth node on a car closer to the caboose;
whereby the plurality of Bluetooth nodes are cooperatively operable for transmitting shipment information from Bluetooth node to Bluetooth node in a backward car-to-car direction along the train towards the caboose and the gateway device.

5. The system of claim 1, wherein each of the one or more Bluetooth nodes includes a universally unique identifier (UUID) defining shipment information for a corresponding car on which it is positioned.

6. The system of claim 5, wherein the shipment information includes contents, destination, and/or identification of the corresponding car.

7. The system of claim 1, wherein the one or more Bluetooth nodes comprise a Bluetooth beacon and/or a Bluetooth low energy (BLE) beacon.

8. The system of claim 1, wherein the gateway device is configured to transmit the payload information to the database over a global system for mobile communications (GSM) gateway.

9. The system of claim 1, wherein the train includes a satellite navigation receiver configured to determine a location of the train, the gateway device configured to transmit location information for the train to the database.

10. The system of claim 1, wherein:
each of the one or more Bluetooth nodes includes limited power and/or a directed antenna to substantially inhibit each Bluetooth node from communicating with other Bluetooth nodes outside of the train; and/or
each of the one or more Bluetooth nodes includes a directional antenna configured to generate a polar conical beam to limit Bluetooth communication to direction fore and aft relative to a longitudinal axis of the train.

11. The system of claim 1, wherein each of the one or more Bluetooth nodes is configured to obtain shipment information from contents of a car on which it is positioned by receiving information from one or more tags attached to the contents of the car.

12. The system of claim 1, wherein each of the one or more Bluetooth nodes is configured to communicate with other Bluetooth nodes using a Bluetooth 4.1 protocol.

13. A train comprising a plurality of cars and the system of claim 1, wherein:
each car includes at least one of the one or more Bluetooth nodes;
each Bluetooth node is configured to transmit shipment information for a corresponding car on which it is positioned to another Bluetooth node on another car that is closer to the gateway device;
the gateway device is configured to receive shipment information for each of the plurality of cars; and
the gateway device is configured to transmit payload information to the database, the payload information including an aggregation of shipment information for each of the plurality of cars.

14. A shipment tracking method for a train having one or more cars, the method comprising:
obtaining, via one or more Bluetooth nodes onboard the one or more cars, shipment information for the one or more cars;
relaying, via at least one of the one or more Bluetooth nodes, the shipment information for the one or more cars to a gateway device onboard the train; and
transmitting, via the gateway device, payload information to a database, the payload information including the shipment information for the one or more cars.

15. The method of claim 14, wherein the one or more Bluetooth nodes comprise a plurality of Bluetooth nodes, and wherein the method includes:
obtaining, via the plurality of Bluetooth nodes each located at one of a plurality of cars of a train, shipment information for each of the cars;
relaying, via at least one of the plurality of Bluetooth nodes, the shipment information for each of the cars to the gateway device; and
transmitting, via the gateway device, payload information to the database, the payload information including an aggregation of shipment information for each of the plurality of cars to the database.

16. The method of claim 14, wherein relaying shipment information includes receiving shipment information at a Bluetooth node from another Bluetooth node corresponding to a car farther from the gateway device and then transmitting the received shipment information from the Bluetooth node to another Bluetooth node corresponding to a car closer to the gateway device.

17. The method of claim 14, wherein:
transmitting payload information includes transmitting location information indicating a location of the train; and/or
the shipment information includes contents, destination, and/or identification of the corresponding car.

18. The method of claim 14, wherein relaying includes directing a Bluetooth signal along a longitudinal axis of the train to inhibit Bluetooth communication with Bluetooth nodes outside of the train.

19. A method of providing a train with a shipment tracking system, the method comprising:
positioning one or more Bluetooth nodes onboard one or more cars of the train, the one or more Bluetooth nodes configured to transmit shipment information for the one or more cars; and
positioning a gateway device onboard the train, the gateway device configured to receive shipment information for the one or more cars, the gateway device configured to transmit payload information to a database, the payload information including the shipment information for the one or more cars.

20. The method of claim 19, wherein:
positioning one or more Bluetooth nodes comprises positioning a Bluetooth node on each of a plurality of cars of the train, each Bluetooth node configured to transmit shipment information for a corresponding car on which it is positioned to another Bluetooth node on another car that is closer to the gateway device; and
the gateway device is configured to receive shipment information for each of the plurality of cars and to transmit payload information including an aggregation of shipment information for each car of the plurality of cars of the train to a database.
